(19) United States
(12) Patent Application Publication
(10) Pub. No.: US 2024/0420128 A1
(43) Pub. Date: Dec. 19, 2024

(54) BLOCKCHAIN-BASED SMART CONTRACT FOR TRUSTED OWNERSHIP VOUCHERS

(71) Applicant: DELL PRODUCTS L.P., Round Rock, TX (US)

(72) Inventors: Kah Wai Au, Singapore (SG); Jia Yuan Chia, Singapore (SG); Soong Li Ching, Singapore (SG)

(21) Appl. No.: 18/337,327

(22) Filed: Jun. 19, 2023

(51) Int. Cl. G06Q 20/38; G06Q 20/36

(52) U.S. Cl. CPC G06Q 20/389; G06Q 20/3672; G06Q 20/3829

(57) ABSTRACT

An information handling system executes a smart contract when a condition of ownership transfer of a device between a buyer and a seller is met. The system creates a transaction that is signed by the seller in a blockchain and generates an output associated with the transaction that includes extending an ownership voucher of the device from the seller to the buyer.

### FIELD OF THE DISCLOSURE

The present disclosure generally relates to information handling systems, and more particularly relates to a blockchain-based smart contract for trusted ownership vouchers.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system executes a smart contract when a condition of ownership transfer of a device between a buyer and a seller is met. The system creates a transaction that is signed by the seller in a blockchain and generates an output associated with the transaction that includes extending an ownership voucher of the device from the seller to the buyer.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an environment for a blockchain-based smart contract for trusted ownership vouchers, according to an embodiment of the present disclosure;

FIG. 3 is a block diagram illustrating an environment for a blockchain-based smart contract for trusted ownership vouchers, according to an embodiment of the present disclosure;

FIG. 4 is a block diagram illustrating a block in a blockchain-based smart contract for trusted ownership vouchers, according to an embodiment of the present disclosure; and

FIG. 5 is a flowchart illustrating a method for blockchain-based smart contract for trusted ownership vouchers, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

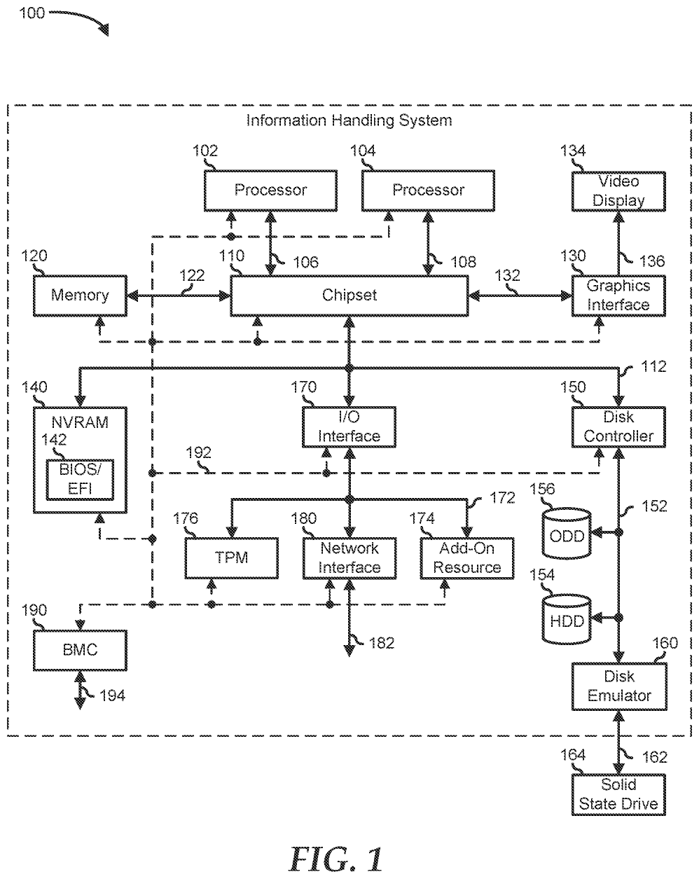

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure, information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Device onboarding, also referred to as device provisioning, is a process of automatically installing secrets and configuration data into a device. This allows the device to interact and/or connect with a platform, such as an internet of things (IoT) platform. The onboarding mechanism may include a digital proof of ownership of the device, which typically includes a certificate chain. However, usually it is still up to a current owner of the device to manually decide whether to trust or distrust the certificate chain. Thus, the device onboarding process is generally not fully automated. To address this issue and other concerns, the present disclosure provides a system and method to establish an external trust relationship with the supply chain of the device facilitating a fully automated device onboarding or provisioning which reduces onboarding costs.

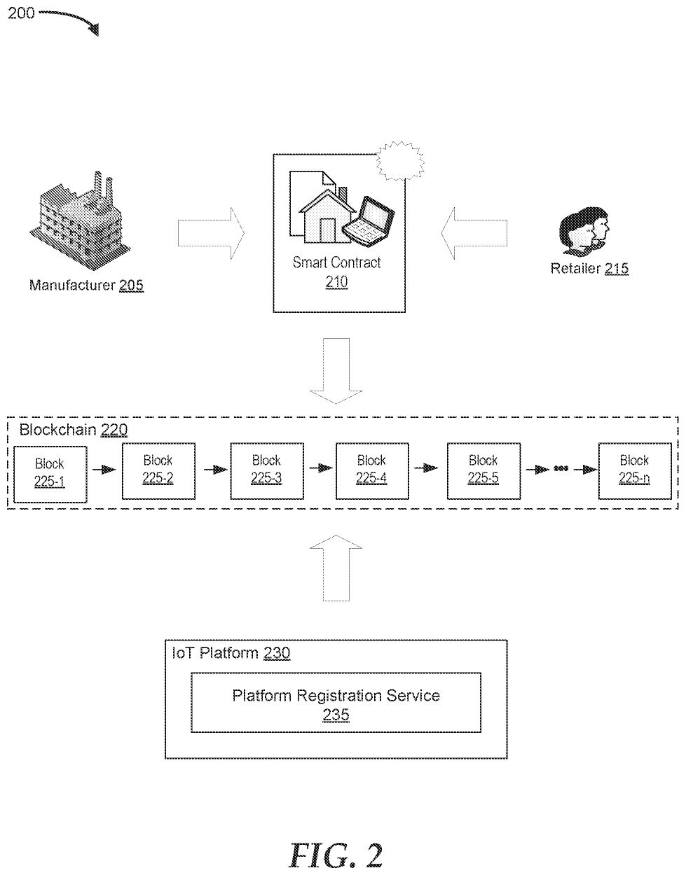

FIG. 2 shows an environment 200 for a blockchain-based smart contract for trusted ownership vouchers. Environment 200 includes a manufacturer 205, a smart contract 210, a retailer 215, a blockchain 220, and an IoT platform 230 that includes a platform registration service 235. Blockchain 225 includes blocks 225-1 through 22-n. Environment 200 includes a system and method to facilitate an ownership voucher that can be trusted by various stakeholders, such as manufacturer 205 and retailer 215, during the onboarding of a device. The components of environment 200 may be implemented in hardware, software, firmware, or any combination thereof. The components shown are not drawn to scale and environment 200 may include additional or fewer components. In addition, connections between components may be omitted for descriptive clarity.

Smart contract 210 and blockchain 220 may be hosted by an information handling system similar to information handling system 100 of FIG. 1. IoT platform 230 may be hosted locally or remotely by another information handling system. IoT platform 230 may be communicatively coupled with manufacturer 205, smart contract 210, and retailer 215 via a network. Accordingly, blockchain 220 may also be accessible by manufacturer 205, retailer 215, and IoT platform 230 via the network. In certain embodiments, the network may be a public network, such as the Internet, a physical private network, a wireless network, a virtual private network, or any combination thereof. Smart contract 210 may use various communication protocols upon execution. For example, smart contract 210 may use one of Hypertext Transfer Protocol (HTTP), HTTP Secure, File Transfer Protocol, or any suitable protocol or combination of protocols.

Manufacturer 205 may represent a factory or manufacturer of the device associated with the present disclosure. The device also referred to herein as an object, may be an edge computing or an IoT device, such as a sensor, actuator, gadget, appliance, machine, etc. Retailer 215 may purchase the device from manufacturer 205. Ownership of the device may then transfer to retailer 215 from manufacturer 205 upon final payment by retailer 215. Similarly, ownership of the device transfers from retailer 215 to a consumer upon purchase of the device by the consumer.

A smart contract may represent an executable binding agreement between stakeholders, such as a seller and a buyer of the device. For example, smart contract 210 may represent an executable contractual binding agreement between manufacturer 205 and retailer 215. Smart contract 210 may include self-executing lines of code with contractual agreement terms between manufacturer 205 and retailer 215 that may be deployed to blockchain 220. Blockchain 220 is a historical record of how different objects, also referred to herein as devices, arrived at their current state which includes their current state of ownership. Blockchain 220 may be a consortium blockchain network that allows organizations, also referred to herein as stakeholders, with a common goal of facilitating protocols, such as fast identity online (FIDO) protocol, secure device onboard protocol by Intel®, or similar for a secure transfer of device ownership.

Smart contract 210 may be triggered to execute autonomously when a condition of smart contract 210 is met. For example, completion or payment of a purchase order may trigger the execution of certain lines of code in smart contract 210 for ownership transfer. In one embodiment, smart contract 210 may extend the ownership voucher to retailer 215 from manufacturer 205. The ownership voucher is a digital document that links manufacturer 205, also referred to herein as the seller, and retailer 215, also referred to herein as the buyer. Signatures in the ownership voucher create a chain of trust from a manufacturer to a current owner. Smart contract 210 may also create an immutable transaction on blockchain 220 that includes the ownership voucher which is securely encrypted with a public key of retailer 215. The ownership voucher may also be encrypted using an address of an electronic wallet of retailer 215. Further, smart contract 210 may add a new block in blockchain 220 when manufacturer 205 sells the device to retailer 215. Smart contract 210 may add another block in blockchain 220 when retailer 215 sells the device, and so on. This creates a chain of trusted ownership vouchers that may be used for automatically onboarding a device or object without user intervention.

The present disclosure may leverage a smart contract to automate the extension of an ownership voucher with approved contractual clauses converted into an executable smart contract on a blockchain. This may automate a trusted immutable ownership voucher transfer on the blockchain once all contractual clauses are met without involvement of a third party. The present disclosure may use a consortium blockchain to further enhance the trust among network nodes in the blockchain. Stakeholders in the supply chain of a FIDO-enabled IoT device may join the blockchain network. The present disclosure provides off-chain computation using a private blockchain of the stakeholders for an efficient and cost-saving manner of smart contract execution.

Retailer 215 can register the ownership voucher with IoT platform 230 via platform registration service 235. Since IoT platform 230 is part of a blockchain network, it can retrieve the ownership voucher using a block address. IoT platform 230 may also decrypt the ownership voucher using a private key of retailer 215 and register the ownership voucher. The private key of retailer 215 may be stored in its electronic wallet. In another embodiment, the electronic wallet may be used as the private key. This process may facilitate a trusted external ownership voucher throughout the supply chain using smart contract 210.

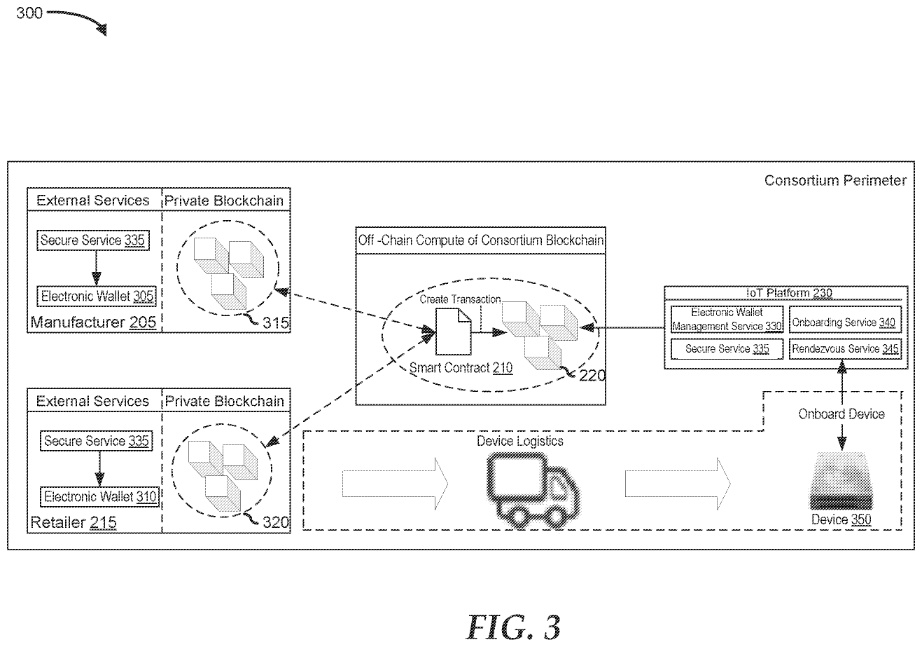

FIG. 3 shows a diagram of an environment 300 that outlines a perimeter associated with a consortium blockchain network. The environment includes a group of organizations or stakeholders, such as manufacturer 205 and retailer 215, inside the consortium perimeter. The stakeholders may operate the consortium blockchain network to facilitate a device onboarding protocol, such as via FIDO transfer ownership protocol or similar. In addition to the stakeholders, environment 300 also includes IoT platform 230. In this example, IoT platform 230 includes an electronic wallet management service 330, a secure service 335, an onboarding service 340, and a rendezvous service 345.

Electronic wallet management service 330 may be used by IoT platform 230 to manage electronic wallets of the stakeholders included in the consortium. For example, electronic wallet management service 330 may be used by manufacturer 205 to access electronic wallet 305. Similarly, retailer 215 may use electronic wallet management service 330 to access electronic wallet 310. An electronic wallet may be used to store a stakeholder's public key that is typically used to encrypt an ownership voucher. In another embodiment, IoT platform 230 may use an address of an electronic wallet as the stakeholder's public key. Secure service 335, which is similar to a FIDO service, provides authentication and/or security services. Rendezvous service 345 may provide protocol support for stakeholder and/or device ownership discovery. While onboarding service 340 may be used by an owner for onboarding devices, such as onboarding a device 350. These services may be implemented using a simple object access protocol, a representational state transfer, or similar.

Smart contract 210 may include self-executing lines of codes associated with contractual terms of an agreement between the stakeholders. For example, the outcome of the contractual agreement between the stakeholders may be coded as terms of smart contract 210. The terms may include conditions, such as proof of ownership of device 350, and proof of sale between a seller and a buyer, such as payments, sale orders, purchase orders, etc. Smart contract 210 may be used to automatically verify various components of blockchain 220. Smart contract 210 may also execute at blockchain 220.

Smart contract 210 may include metadata to facilitate ownership transfer of the device. For example, the metadata may include a globally unique identifier (GUID) of an ownership voucher, a secure service for the ownership voucher extension, such as secure service 335, and an address of an electronic wallet of the buyer. The ownership voucher may represent a digital proof of ownership of device 350 and may be used to facilitate a transfer of ownership credentials from a previous owner to a new owner. The ownership voucher GUID may be used to uniquely identify the ownership voucher. Secure service 335 may be hosted by the seller to extend the ownership voucher to the new owner of the device. For example, secure service 335 may be hosted by manufacturer 205. The address of the electronic wallet of the new owner of the device may include a public key and may be signed by the seller and encrypt the extended ownership voucher. In this example, manufacturer 205 may be the seller while retailer 215 may be the buyer. The extended ownership voucher may refer to an ownership voucher wherein ownership of the device has been extended to the new owner, such as retailer 215 in this example.

Smart contract 210 may be deployed on blockchain 220 and may execute the contractual agreement between manufacturer 205 and the retailer regarding the ownership transfer of device 350. Once a condition(s) of smart contract 210 is met, it may execute an off-chain computation of blockchain 220. The off-chain computation may be based on private blockchains 315 and 320 of manufacturer 205 and retailer 215 respectively. In one embodiment, blockchain 220 may be a consortium blockchain network among the stakeholders. The off-chain computation of blockchain 220 may promote a cost-efficient smart contract execution by offloading the ownership voucher extension off-chain. The off-chain computation of blockchain 220 may also provide enhanced privacy where private data is not posted on-chain for another stakeholder to see. For example, retailer 215 may not be able to see data associated with private blockchain 315 that is not posted to blockchain 220. Accordingly, manufacturer 205 may not be able to see data associated with private blockchain 320 that is not posted to blockchain 220.

Private blockchain 315 may be generated by manufacturer 205 via an off-chain computation using external services of IoT platform 230, such as a secure service 335 and an electronic wallet 305. Onboarding service 340 may be a FIDO service or similar which may be used to authenticate device 350. However, a stakeholder can give permission to IoT platform 230 to access blockchain 220, wherein IoT platform 230 can read the ownership voucher included in blockchain 220. The stakeholder may also give permission to another stakeholder to access blockchain 220.

Private blockchain 315 or a block thereof may be generated based on data read from blockchain 220. An extension of the ownership voucher may also be performed via the off-chain computation. The generation of the ownership voucher, wherein manufacturer 205 is an owner may be performed using secure service 335 using a public key of manufacturer 205. The generated ownership voucher can be stored in private blockchain 315. When the device is sold to retailer 215, smart contract 210 may trigger an off-chain computation of private blockchain 315 which extends the generated ownership voucher to retailer 215 via secure service 335 and an electronic wallet 310 using a public key of retailer 215.

Smart contract 210 may create a transaction that is endorsed by a current owner and a new owner on a blockchain. For example, smart contract 210 may create a transaction that is endorsed by manufacturer 205 and retailer 215 on blockchain 220. Smart contract 210 may also trigger an off-chain computation to extend the ownership voucher to a new owner, such as a consumer. The extended ownership voucher may be encrypted with the owner's public key or an address of the owner's electronic wallet. For example, upon detecting a full payment of device 350 by the consumer to retailer 215, smart contract 210 may execute code that would create a transaction in blockchain 220 associated with the full payment. In addition, smart contract 210 may trigger an off-chain computation to extend the ownership voucher in blockchain 320 to the consumer. IoT platform 230 can also load the ownership voucher to onboarding service 340.

The logistics of device 350 to the consumer may happen in parallel with the off-chain computation of blockchain 220 and/or private blockchains 315 and 320. Upon arrival of device 350 to the consumer, the consumer may then start using device 350, which includes booting the device. Once device 350 is booted up, it may communicate with the IoT platform 230 and/or onboarding service 340 to perform onboarding tasks. During the onboarding process, the consumer who is now a current owner of device 350 can request the ownership voucher from blockchain 220 via secure service 335 after successful authentication. Secure service 335 may access the current owner's wallet and retrieve a specific ownership voucher from blockchain 220 which is part of the blockchain network. During the retrieval, secure service 335 may be able to decrypt the ownership voucher using a private key in the current owner's wallet. The current owner can then load the decrypted ownership voucher to onboarding service 340 and transfer the ownership to the consumer from retailer 215. The retrieval of the ownership voucher directly from the blockchain network during device onboarding leverages the consensus mechanism of the blockchain to ensure only a trusted ownership voucher that can be received by the current owner. It may also ensure that only the valid owner may be able to access the appropriate ownership voucher. None of the other parties or stakeholders may be able to decrypt the ownership voucher or tamper with its data. Thus, creating a trusted ownership voucher chain among the stakeholders.

The present disclosure adopts blockchain technology to increase trust, security, and traceability of data which is essential for all stakeholders to fully trust the ownership voucher. In addition, the present disclosure may use the consortium blockchain for building strong confidence and trust. It also allows a new stakeholder to join the established structure. Besides, having a permissioned blockchain ensures that there are only known and verified stakeholders, and stakeholders can only perform specific actions by identifying themselves through certificates or other digital means. The permission blockchain may allow for easy tracking of changes and by restricting access, it adds privacy and security to the blockchain. Instead of a sole entity, a group of stakeholders may control the blockchain, agreeing to the rules of the smart contract, and achieving consensus to speed operation as well as improve scalability.

Accordingly, the transfer of ownership vouchers along the device's supply chain can be guaranteed on a secure channel. A stakeholder also referred to herein as a member of the consortium may be able to leverage the distributed network to facilitate the transfer of the ownership voucher securely in a trusted manner. Rather than setting up transaction channels between all the stakeholders that intend to transact on FIDO-enabled devices, the present disclosure may put in place a uniform mechanism for all the stakeholders to comply with and make it easy for any stakeholder to participate in transactions. The decentralized nature also means that it does not rely on any single stakeholder to maintain it. Because the consortium blockchain is jointly created by stakeholders in the supply chain, there is an incentive to keep the blockchain network alive. The smart contract can also introduce a transaction fee as an incentive to main the blockchain network nodes.

Those of ordinary skill in the art will appreciate the configuration and/or architecture of environments 200 and 300 in FIG. 2 and FIG. 3 may vary. For example, the illustrative components within environments 200 and 300 are not intended to be exhaustive but rather are representative to highlight components that can be utilized to implement aspects of the present disclosure. For example, other components may be used in addition to or in place of the components depicted. The depicted example does not convey or imply any architectural or other limitations with respect to the presently described embodiments and/or the general disclosure. In the discussion of the figures, reference may also be made to components illustrated in other figures for continuity of the description.

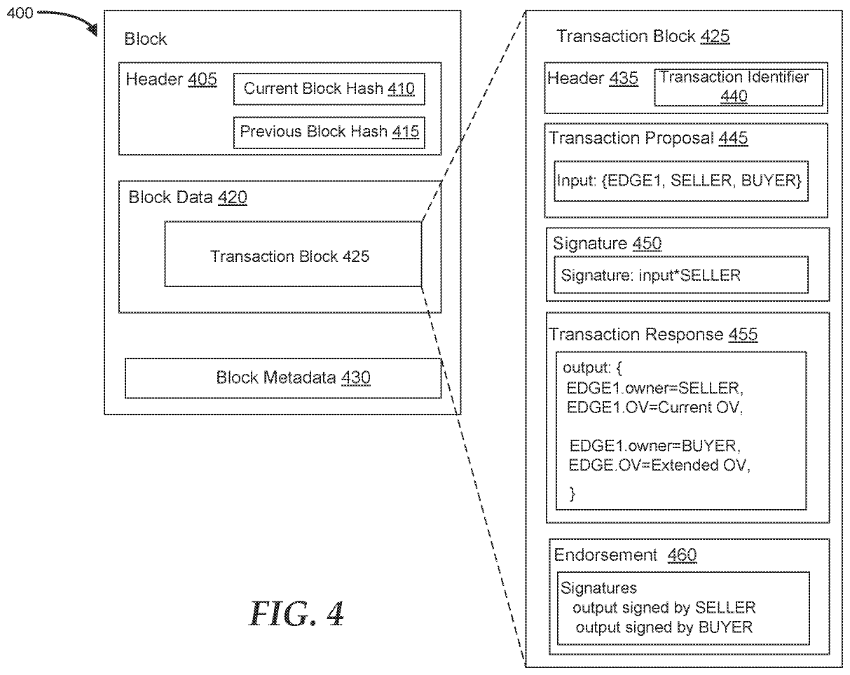

FIG. 4 shows a block 400 of a blockchain utilized by a blockchain-based smart contract for trusted ownership vouchers. Block 400 may be a data object or structure that holds a transaction, such as transaction block 425 in block data 420. Block 400 also includes a header 405 and a block metadata 430. Header 405 includes a current block hash 410 and a previous block hash 415. Current block hash 410 represents a hash of block 400. Previous block hash 415 represents a hash of a previous/parent block in a blockchain. Current block hash 410 and previous block hash 415 may ensure that no data in block 400 may be changed. Block metadata 430 specifies information associated with block 400. Block metadata 430 may include a block version, a timestamp, etc.

Transaction block 425 may represent an exchange, a transaction, or an interaction between a buyer and a seller. Transaction block 425 can be initiated by executing a smart contract with the defined set of input parameters as a transaction proposal. Once the transaction proposal is submitted to the smart contract, it may check if all the conditions have been fulfilled in order to carry out the changes to the world state of the blockchain. The changes in the blockchain may be captured as a transaction response, which includes both the current state and the new state to be written if the transaction is proven to be valid. In order to validate the change, the transaction may be endorsed by both the buyer and the seller of the device, as depicted in endorsement 460. For example, transaction response 455 includes a transfer of the ownership of the device, as depicted in the extension of the ownership voucher to the buyer of the device.

Transaction block 425 includes a transaction identifier as a header to identify a specific transaction. For example, transaction block 425 includes a header 435 which further includes a transaction identifier 440. The transaction block may be generated when the smart contract is executed by a party of the blockchain network. For example, in transaction block 425, the smart contract was executed by the seller as depicted by signature 450, wherein an input is signed by the seller. The seller may include a pre-defined set of input parameters that have been agreed upon by the stakeholders of the smart contract. In one example, the input parameters to facilitate a sale of a device may include a device identifier, the seller's off-chain computation URL, the buyer's electronic wallet address, etc. In this example, EDGE1 represents the device identifier, SELLER represents the seller's off-chain computation URL, and BUYER represents the wallet address, as depicted in transaction proposal 445. Additional details and/or input parameters may be included.

The transaction proposal may be signed by the seller before submitting it to the smart contract. The smart contract may verify whether conditions associated with the transaction proposal are fulfilled before responding with a transaction output. The transaction output may include information associated with a current and a new ownership state of the device. In this example, transaction response 455 includes the current ownership state as depicted where the device's current owner (SELLER) is associated with the current ownership voucher (EDGE1.OV=Current OV), wherein current OV identifies the current ownership voucher. The transaction response also includes the new ownership state as depicted where the device's new owner (BUYER) is associated with the extended ownership voucher (EDGE1.OV=Extended OV), wherein extended OV identifiers the extended ownership voucher.

The transaction output, which includes an ownership voucher, may then be endorsed by both the seller and the buyer, as depicted in endorsement 460. For example, the transaction input may include the current ownership voucher and the extended ownership voucher. In another embodiment, the transaction input may include a pointer to the current ownership voucher and the extended ownership voucher. The transaction output may be used to update the world state associated with the device. The world state is the current state of all objects, such as the ownership and ownership voucher. For example, a new block may be generated when the current buyer sells the device, and the world state is updated accordingly.

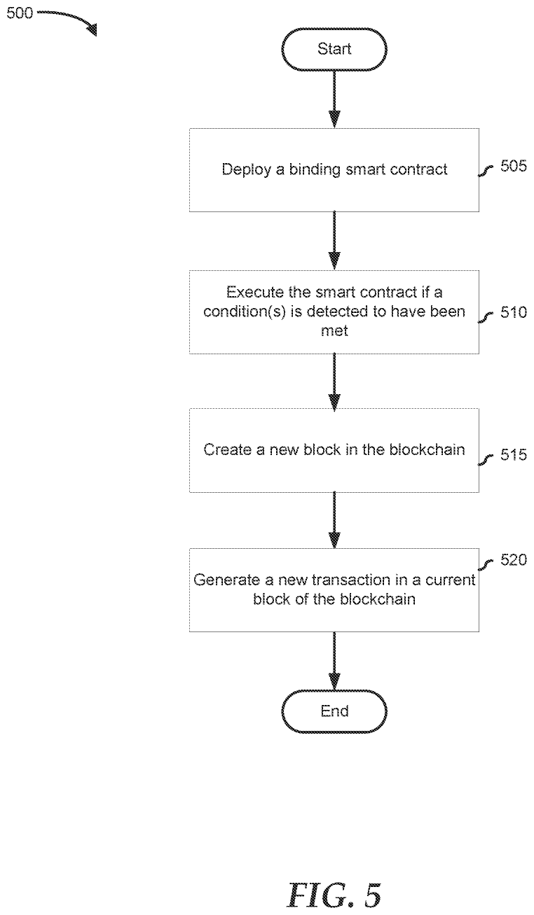

FIG. 5 shows a flowchart of a method 500 for blockchain-based smart contract for trusted ownership vouchers. Method 500 may be performed by one or more components of environment 200 of FIG. 3. Method 500 may also be performed by one or more components of environment 300 of FIG. 3. However, while embodiments of the present disclosure are described in terms of environment 300 of FIG. 2 or environment 300 of FIG. 3, it should be recognized that other systems may be utilized to perform the described method. One of skill in the art will appreciate that this flowchart explains a typical example, which can be extended to advanced applications or services in practice.

Method 500 typically starts at block 505, where a contractual binding smart contract is deployed at a consortium with one or more stakeholders. The method proceeds to block 510 where the smart contract may automatically execute when it detects that one or more conditions of an agreement between at least two stakeholders are met. The method proceeds to block 515 where the smart contract generates a new block and is added to the blockchain.

A new block may be generated in the blockchain when a previous buyer of a device becomes a seller and sells the device to another buyer. For example, a new block may be generated when a retailer who previously bought the device from a manufacturer now sells the device to a consumer. A block may have also been generated when the manufacturer sold the device to the retailer. A new block may also be generated when the manufacturer finished manufacturing the device but has not yet sold the device. Accordingly, the blockchain may include at least one block when sold to the consumer. The new block may now be considered a current block. The method proceeds to block 520, wherein a new transaction is generated in the current block. Afterwards, the method ends.

Although FIG. 5 shows example blocks of method 500 in some implementations, method 500 may include additional blocks, fewer blocks, different blocks, or differently arranged blocks than those depicted in FIG. 5. Those skilled in the art will understand that the principles presented herein may be implemented in any suitably arranged processing system. Additionally, or alternatively, two or more of the blocks of method 500 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
executing, by a processor, a smart contract when a condition of ownership transfer of a device between a buyer and a seller is met;
creating a transaction that is signed by the seller in a blockchain; and
generating an output associated with the transaction that includes extending an ownership voucher of the device from the seller to the buyer.

2. The method of claim 1, wherein the smart contract includes a binding contractual agreement between the buyer and the seller of the device.

3. The method of claim 1, wherein the blockchain is a consortium blockchain with the buyer and the seller as stakeholders.

4. The method of claim 1, adding a new block in the blockchain when the buyer sells the device.

5. The method of claim 1, wherein the output is signed by the buyer and the seller.

6. The method of claim 1, wherein an input for the transaction is signed by the seller.

7. The method of claim 1, wherein the ownership voucher is encrypted using a public key of an owner.

8. The method of claim 1, wherein a fast identity online service can decrypt the ownership voucher included in the blockchain using a private key within an electronic wallet of the buyer during an onboarding process of the device.

9. An information handling system, comprising:
a processor; and
a memory storing code that when executed causes the processor to perform operations, the operations including:
executing a smart contract when a condition of ownership transfer of a device between a buyer and a seller is met;
creating a transaction that is signed by the seller in a blockchain; and
generating an output associated with the transaction that includes extending an ownership voucher of the device from the seller to the buyer.

10. The information handling system of claim 9, wherein the smart contract includes a binding contractual agreement between the buyer and the seller of the device.

11. The information handling system of claim 9, wherein the blockchain is a consortium blockchain with the buyer and the seller as stakeholders.

12. The information handling system of claim 9, adding a new block in the blockchain when the buyer sells the device.

13. The information handling system of claim 9, wherein the output is signed by the buyer and the seller.

14. The information handling system of claim 9, wherein an input for the transaction is signed by the seller.

15. A non-transitory computer-readable medium to store instructions that are executable to perform operations comprising:
executing a smart contract when a condition of ownership transfer of a device between a buyer and a seller is met;
creating a transaction that is signed by the seller in a blockchain; and
generating an output associated with the transaction that includes extending an ownership voucher of the device from the seller to the buyer.

16. The non-transitory computer-readable medium of claim 15, wherein the smart contract includes a binding contractual agreement between the buyer and the seller of the device.

17. The non-transitory computer-readable medium of claim 15, adding a new block in the blockchain when the buyer sells the device.

18. The non-transitory computer-readable medium of claim 15, wherein the output is signed by the buyer and the seller.

19. The non-transitory computer-readable medium of claim 15, wherein an input for the transaction is signed by the seller.

20. The non-transitory computer-readable medium of claim 15, wherein the ownership voucher is encrypted using a public key of an owner.
